(19) United States
(12) Patent Application Publication
(10) Pub. No.: US 2006/0006966 A1
(43) Pub. Date: Jan. 12, 2006

(54) Electronically tunable ridged waveguide cavity filter and method of manufacture therefore

(76) Inventors: Qinghua Kang, Newark, DE (US); Nicolaas DuToit, Columbia, MD (US); Rousslan Goulouev, Kitchener (CA); Yongfei Zhu, Ellicott City, MD (US)

Correspondence Address: James S. Finn;c/o William Tucker, 14431 Goliad Dr., Box #8, Malakoff, TX, 75148, US

(21) Appl. No.: 11/154,507

(22) Filed: Jun. 16, 2005

Related U.S. Application Data
(60) Provisional application No. 60/586,267, filed on Jul. 8, 2004.

(51) Int. Cl. H01P 1/208

(52) U.S. Cl. 333/209

(57) ABSTRACT

An embodiment of the present invention provides a voltage-controlled tunable filter, comprising a tunable ridged waveguide filter formed from a first ridged waveguide cavity coupled to a second ridged waveguide cavity thereby forming a resonator; and one or more tunable capacitors in at least one of said first or second waveguide cavity. The coupling between said first ridged waveguide and said second ridged waveguide may be via a coupling iris or ridged post and the one or more tunable capacitors may comprise a low loss tunable dielectric material and metallic electrodes with predetermined shape, size, and distance. In an embodiment of the present invention the one or more tunable capacitors may be MEMS tunable capacitors that are either parallel plate or interdigital topology. The tunable ridged waveguide filter may be formed from two or more ridged-waveguide resonators and may include an RF Input and RF output connected to the resonator and may be direct coupling probes that are either electric or magnetic. Further, the RF input and RF output proximity coupling may be either electric or magnetic. The inter-cavity coupling may be controlled by the distance and area of the ridged posts.

### BACKGROUND OF THE INVENTION

Electrically tunable microwave filters have found wide range of applications in microwave systems. Compared to mechanically and magnetically tunable filters, electronically tunable filters have the most important advantage of fast tuning capability over wide frequency band application. Because of this advantage, they can be used in the applications such as, but not limited to LMDS (local multipoint distribution service), cellular, PCS (personal communication system), frequency hopping, satellite communication, and radar systems. Electronically tunable filtersmay be divided into two types: one is based on voltage-controlled tunable dielectric capacitorand the other is based on semiconductor varactor. Compared to semiconductor varactor based tunable filters, tunable dielectric capacitor based tunable filters have the merits of lower loss, higher power-handling, and higher IP3, especially at higher frequencies (>10 GHz).

Tunable filters have been developed for microwave radio applications. They may be tuned electronically using dielectric varactors. Tunable filters offer service providers flexibility and scalability never before accessible. A single tunable filter solution enables radio manufacturers to replace several fixed filters needed to cover a given frequency band. This versatility provides front end RF tunability in real time applications and decreases deployment and maintenance costs through software control and reduced component count. Also, fixed filters need to be wide band so that their count does not exceed reasonable numbers to cover the desired frequency plan. Tunable filters, however, are narrow band, and may be tuned in the field by remote command. Additionally, narrowband filters at the front end are appreciated from the systems point of view, because they provide better selectivity and help reduce interference from nearby transmitters.

### SUMMARY OF THE INVENTION

An embodiment of the present invention provides a voltage-controlled tunable filter, comprising a tunable ridged waveguide filter formed from a first ridged waveguide cavity coupled to a second ridged waveguide cavity thereby forming a resonator; and one or more tunable capacitors in at least one of said first or second waveguide cavity. The coupling between said first ridged waveguide and said second ridged waveguide may be via a coupling iris or ridged post and the one or more tunable capacitors may comprise a low loss tunable dielectric material and metallic electrodes with predetermined shape, size, and distance. In an embodiment of the present invention the one or more tunable capacitors may be MEMS tunable capacitors that are either parallel plate or interdigital topology. The tunable ridged waveguide filter may be formed from two or more ridged-waveguide resonators and may include an RF Input and RF output connected to the resonator and may be direct coupling probes that are either electric or magnetic. Further, the RF input and RF output proximity coupling may be either electric or magnetic. The inter-cavity coupling may be controlled by the distance and area of the ridged posts.

An embodiment of the present invention also provides a method of manufacturing a voltage-controlled tunable filter, comprising forming a tunable ridged waveguide filter from a first ridged waveguide cavity coupled to a second ridged waveguide cavity thereby forming a resonator; and placing one or more tunable capacitors in at least one of said first or second waveguide cavity. The method of this embodiment provides the coupling between the first ridged waveguide and said second ridged waveguide may be via a coupling iris or ridged post and the method may further comprise forming the one or more tunable capacitors with a low loss tunable dielectric material and metallic electrodes with predetermined shape, size, and distance. The present method may further comprise forming the tunable ridged waveguide filter from two or more ridged-waveguide resonators.

Another embodiment of the present invention provides a voltage-controlled tunable filter, comprising a waveguide cavity, at least one ridged post disposed therein, and at least one tunable varactor within said waveguide cavity enabling tunability. The present embodiment may further comprise at least one coupling post associated with said at least one ridged post, wherein inter-cavity coupling may be controlled by the distance and area of said ridged posts.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates the assembly of a two-pole ridged waveguide cavity filter of one embodiment of the present invention;

FIG. 2 illustrates an RF I/O coupling of a two-pole ridged waveguide filter of one embodiment of the present invention;

FIG. 3 shows a tunable ridged waveguide filter one embodiment of the present invention;

FIG. 4 shows the response of the tunable ridged waveguide filter of one embodiment of the present invention with no bias;

FIG. 5 depicts the response of the tunable ridged waveguide filter of one embodiment of the present invention under DC bias; and

FIG. 6 illustrates an alternation design configuration of a tunable ridged waveguide filter of one embodiment of the present invention.

### DETAILED DESCRIPTION

Inherent in every tunable filter is the ability to rapidly tune the response using high-impedance control lines. The tunable materials of the present invention enables these tuning properties, as well as, high Q values, low losses and extremely high IP3 characteristics, even at high frequencies. MEMS based varactors can also be used for this purpose. They use different bias voltages to vary the electrostatic force between two parallel plates of the varactor and hence change its capacitance value. They show lower Q than dielectric varactors, and have worse power handling, but can be used successfully for some applications. Also, diode varactors could be used to make tunable filters, although with worse performance and much poorer power handling capability than dielectric varactors.

An embodiment of the present invention provides an electronically tunable filter made in ridged waveguide cavity. The tuning elements may be voltage-controlled tunable dielectric capacitors placed on the ridged posts inside the cavity. Since the tunable capacitors show high Q, high IP3 (low inter-modulation distortion) and low cost, the tunable filter in the present invention has the advantage of low insertion loss, fast tuning speed, and high power handling.

An embodiment of the present invention provides a voltage-tuned filter having low insertion loss, fast tuning speed, high power-handling capability, high IP3 and low cost in the radio frequency range. Compared to MEMS varactors or voltage-controlled semiconductor varactors, voltage-controlled tunable capacitors have higher Q factors, higher power-handling and higher IP3 and may be employed in the filter structure of the present invention.

The tunable dielectric capacitor in the present invention may be made from low loss tunable dielectric material. The range of Q factor of the tunable dielectric capacitor is between 50, for very high tuning material, and 300 or higher, for low tuning material. It also decreases with increasing the frequency, but even at higher frequencies, say 30 GHz, may take values as high as 100. A wide range of capacitance of the tunable dielectric capacitors is available, from several pF to several μF. The tunable dielectric capacitor may be a two-port component, in which the tunable dielectric material may be sandwiched between two specially shaped parallel electrodes. An applied voltage produces an electric field across the tunable dielectric, which produces an overall change in the capacitance of the tunable dielectric capacitor.

The tunable capacitors with microelectromechanical system (MEMS) technology may also be used in the tunable filter of one embodiment of the present invention. At least two varactor topologies may be used, parallel plate and interdigital. In parallel plate structure, one of the plates is suspended at a distance from the other plate by suspension springs. This distance may vary in response to electrostatic force between two parallel plates induced by applied bias voltage. In the interdigital configuration, the effective area of the capacitor is varied by moving the fingers comprising the capacitor in and out and changing its capacitance value. MEMS varactors have lower Q than their dielectric counterpart, especially at higher frequencies, and have worse power handling, but can be used in certain applications.

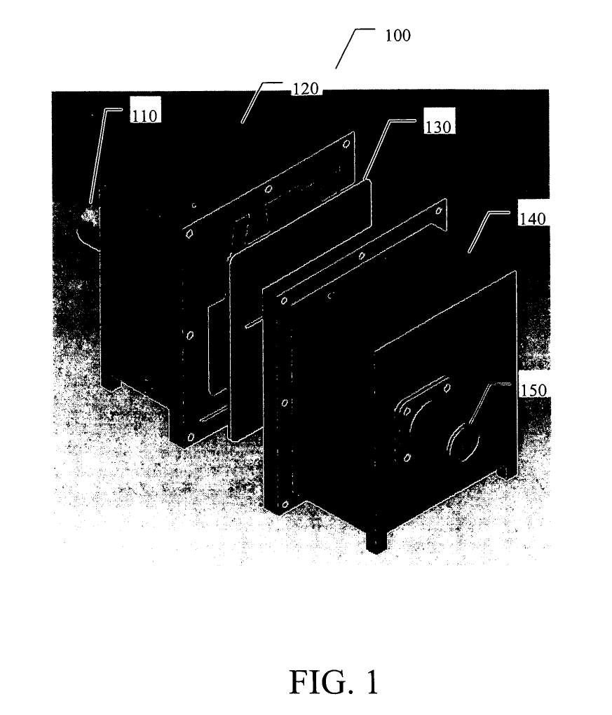

Turning now to FIG. 1, for the purpose of filtering high-power RF signals a ridged waveguide filter 100 capable of withstanding high RF instant voltage and heat dissipation consists of a cavity with predetermined dimensions and two ridged posts 120, 140 forming two filter poles 110, 150 separated by an iris 130 which controls inter-resonator coupling. An iris 130 of varied opening size controls the degree of inter-pole coupling.

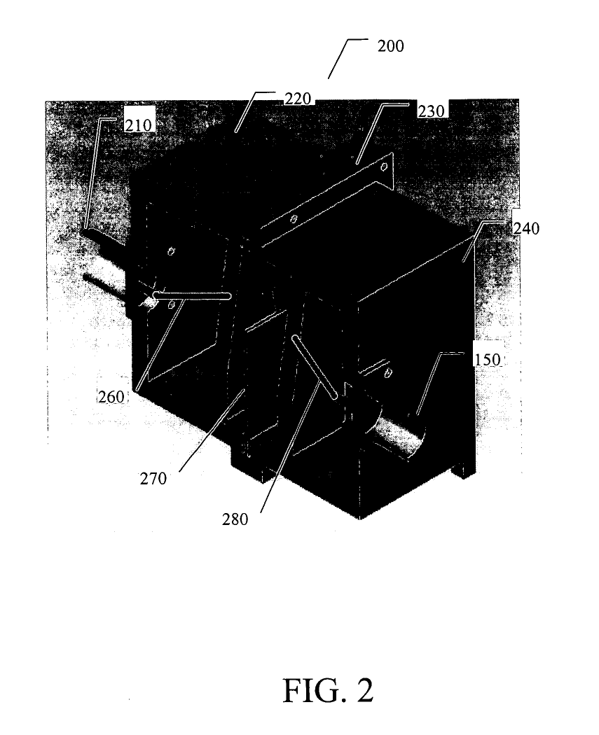

Turning now to FIG. 2, shown generally at 200, is an embodiment of the present invention wherein an RF signal may be coupled in and out from the cavity by N-type connectors 260 and 280 with its center wire soldered to the ridged pos. The position of the I/O coupling on the ridges 220 and 240 controls overall filter I/O coupling. Filters with higher number of poles may be made by simply adding more ridged resonators in between or forming a two-dimensional matrix. In order to improve filter performance and material solderability, the cavities may normally be made from metals of good manufacturabilty (e.g. alumunium) and silver-plated, although the present invention is not limited in this respect.

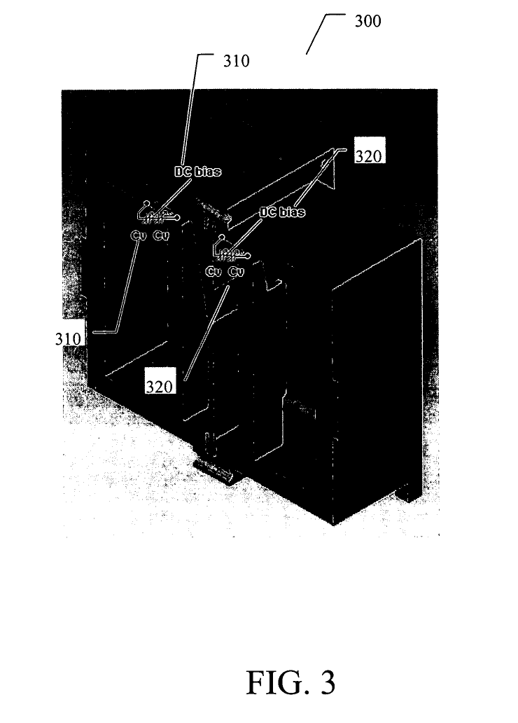

As seen in FIG. 3, generally at 300, to provide tunability to this filter, one or more tunable varactors 310 and 320 may be placed near the open end of the ridged posts and be provided with DC bias 330 and 340. The tunable dielectric varactors in the preferred embodiments of the present invention can include a low loss (Ba,Sr)TiO.sub.3-based composite film. The typical Q factor of the tunable dielectric capacitors is 200 to 500 at 2 GHz with capacitance ratio (C.sub.max/C.sub.min) around 2. A wide range of capacitance of the tunable dielectric capacitors is variable, say 0.1 pF to 10 pF. The tuning speed of the tunable dielectric capacitor is less than 30 ns. The practical tuning speed is determined by auxiliary bias circuits. The tunable dielectric capacitor may be a packaged two-port component, in which tunable dielectric material can be voltage-controlled. The tunable film may preferably be deposited on a substrate, such as MgO, LaAlO.sub.3, sapphire, Al.sub.2O.sub.3 and other dielectric substrates. An applied voltage produces an electric field across the tunable dielectric, which produces a change in the capacitance of the tunable dielectric capacitor.

Tunable dielectric materials have been described in several patents. Barium strontium titanate (BaTiO.sub.3—SrTiO.sub.3), also referred to as BSTO, is used for its high dielectric constant (200-6,000) and large change in dielectric constant with applied voltage (25-75 percent with a field of 2 Volts/micron). Tunable dielectric materials including barium strontium titanate are disclosed in U.S. Pat. No. 5,427,988 by Sengupta, et al. entitled “Ceramic Ferroelectric Composite Material-BSTO—MgO”; U.S. Pat. No. 5,635,434 by Sengupta, et al. entitled “Ceramic Ferroelectric Composite Material-BSTO-Magnesium Based Compound”; U.S. Pat. No. 5,830,591 by Sengupta, et al. entitled “Multilayered Ferroelectric Composite Waveguides”; U.S. Pat. No. 5,846,893 by Sengupta, et al. entitled “Thin Film Ferroelectric Composites and Method of Making”; U.S. Pat. No. 5,766,697 by Sengupta, et al. entitled “Method of Making Thin Film Composites”; U.S. Pat. No. 5,693,429 by Sengupta, et al. entitled “Electronically Graded Multilayer Ferroelectric Composites”; U.S. Pat. No. 5,635,433 by Sengupta entitled “Ceramic Ferroelectric Composite Material BSTO—ZnO”; U.S. Pat. No. 6,074,971 by Chiu et al. entitled “Ceramic Ferroelectric Composite Materials with Enhanced Electronic Properties BSTO—Mg Based Compound-Rare Earth Oxide”. These patents are incorporated herein by reference.

Barium strontium titanate of the formula Ba.sub.xSr.sub.1-xTiO.sub.-3 is a preferred electronically tunable dielectric material due to its favorable tuning characteristics, low Curie temperatures and low microwave loss properties. In the formula Ba.sub.xSr.sub.1-xTiO.sub.3, x can be any value from 0 to 1, preferably from about 0.15 to about 0.6. More preferably, x is from 0.3 to 0.6.

Other electronically tunable dielectric materials may be used partially or entirely in place of barium strontium titanate. An example is Ba.sub.xCa.sub.1-xTiO.sub.3, where x is in a range from about 0.2 to about 0.8, preferably from about 0.4 to about 0.6. Additional electronically tunable ferroelectrics include Pb.sub.xZr.sub.1-xTiO.sub.3 (PZT) where x ranges from about 0.0 to about 1.0, Pb.sub.xZr.sub.1-xSrTiO-.sub.3 where x ranges from about 0.05 to about 0.4, KTa.sub.xNb.sub.l-xO.sub.3 where x ranges from about 0.0 to about 1.0, lead lanthanum zirconium titanate (PLZT), PbTiO.sub.3, BaCaZrTiO.sub.3, NaNO.sub.3, KNbO.sub.3, LiNbO.sub.3, LiTaO.sub.3, PbNb.sub.2O.sub.6, PbTa.sub.2O.sub.6, KSr(NbO.sub.3) and NaBa.sub.2(NbO.sub.3).sub.5 KH.sub.2-PO.sub.4, and mixtures and compositions thereof. Also, these materials can be combined with low loss dielectric materials, such as magnesium oxide (MgO), aluminum oxide (Al.sub.2O.sub.3), and zirconium oxide (ZrO.sub.2), and/or with additional doping elements, such as manganese (MN), iron (Fe), and tungsten (W), or with other alkali earth metal oxides (i.e. calcium oxide, etc.), transition metal oxides, silicates, niobates, tantalates, aluminates, zirconnates, and titanates to further reduce the dielectric loss.

In addition, the following U.S. patent applications, assigned to the assignee of this application, disclose additional examples of tunable dielectric materials: U.S. application Ser. No. 09/594,837 filed Jun. 15, 2000, entitled “Electronically Tunable Ceramic Materials Including Tunable Dielectric and Metal Silicate Phases”; U.S. application Ser. No. 09/768,690 filed Jan. 24, 2001, entitled “Electronically Tunable, Low-Loss Ceramic Materials Including a Tunable Dielectric Phase and Multiple Metal Oxide Phases”; U.S. application Ser. No. 09/882,605 filed Jun. 15, 2001, entitled “Electronically Tunable Dielectric Composite Thick Films And Methods Of Making Same”; U.S. application Ser. No. 09/834,327 filed Apr. 13, 2001, entitled “Strain-Relieved Tunable Dielectric Thin Films”; and U.S. provisional application Ser. No. 60/295,046 filed Jun. 1, 2001 entitled “Tunable Dielectric Compositions Including Low Loss Glass Frits”. These patent applications are incorporated herein by reference.

The tunable dielectric materials can also be combined with one or more non-tunable dielectric materials. The non-tunable phase(s) may include MgO, MgAl.sub.2O.sub.4, MgTiO.sub.3, Mg.sub.2SiO.sub.4, CaSiO.sub.3, MgSrZrTiO.sub.6, CaTiO.sub.3, Al.sub.2O.sub.3, SiO.sub.2 and/or other metal silicates such as BaSiO.sub.3 and SrSiO.sub.3. The non-tunable dielectric phases may be any combination of the above, e.g., MgO combined with MgTiO.sub.3, MgO combined with MgSrZrTiO.sub.6, MgO combined with Mg.sub.2SiO.sub.4, MgO combined with Mg.sub.2SiO.sub.4, Mg.sub.2SiO.sub.4 combined with CaTiO.sub.3 and the like.

Additional minor additives in amounts of from about 0.1 to about 5 weight percent can be added to the composites to additionally improve the electronic properties of the films. These minor additives include oxides such as zirconnates, tannates, rare earths, niobates and tantalates. For example, the minor additives may include CaZrO.sub.3, BaZrO.sub.3, SrZrO.sub.3, BaSnO.sub.3, CaSnO.sub.3, MgSnO.sub.3, Bi.sub.2O.sub.3/2SnO.sub.2, Nd.sub.2O.sub.3, Pr.sub.7O.sub.11, Yb.sub.2O.sub.3, Ho.sub.2O.sub.3, La.sub.2O.sub.3, MgNb.sub.2O.sub.6, SrNb.sub.2O.sub.6, BaNb.sub.2O.sub.6, MgTa.sub.2O.sub.6, BaTa.sub.2O.sub.6 and Ta.sub.2O.sub.3.

Thick films of tunable dielectric composites can comprise Ba.sub.1-xSr.sub.xTiO.sub.3, where x is from 0.3 to 0.7 in combination with at least one non-tunable dielectric phase selected from MgO, MgTiO.sub.3, MgZrO.sub.3, MgSrZrTiO.sub.6, Mg.sub.2SiO.sub.4, CaSiO.sub.3, MgAl.sub.2O.sub.4, CaTiO.sub.3, Al.sub.2O.sub.3, SiO.sub.2, BaSiO.sub.3 and SrSiO.sub.3. These compositions can be BSTO and one of these components or two or more of these components in quantities from 0.25 weight percent to 80 weight percent with BSTO weight ratios of 99.75 weight percent to 20 weight percent.

The electronically tunable materials can also include at least one metal silicate phase. The metal silicates may include metals from Group 2A of the Periodic Table, i.e., Be, Mg, Ca, Sr, Ba and Ra, preferably Mg, Ca, Sr and Ba. Preferred metal silicates include Mg.sub.2SiO.sub.4, CaSiO.sub.3, BaSiO.sub.3 and SrSiO.sub.3. In addition to Group 2A metals, the present metal silicates may include metals from Group 1A, i.e., Li, Na, K, Rb, Cs and Fr, preferably Li, Na and K. For example, such metal silicates may include sodium silicates such as Na.sub.2SiO.sub.3 and NaSiO.sub.3-5H.sub.20, and lithium-containing silicates such as LiAlSiO.sub.4, Li.sub.2SiO.sub.3 and Li.sub.4SiO.sub.4. Metals from Groups 3A, 4A and some transition metals of the Periodic Table may also be suitable constituents of the metal silicate phase.

Additional metal silicates may include Al.sub.2Si.sub.2O.sub.7, ZrSiO.sub.4, KalSi.sub.3O.sub.8, NaAlSi.sub.3O.sub.8, CaAl.sub.2Si.sub.2O.sub.8, CaMgSi.sub.2O.sub.6, BaTiSi.sub.3O.sub.9 and Zn.sub.2SiO.sub.4. The above tunable materials can be tuned at room temperature by controlling an electric field that is applied across the materials.

In addition to the electronically tunable dielectric phase, the electronically tunable materials can include at least two additional metal oxide phases. The additional metal oxides may include metals from Group 2A of the Periodic Table, i.e., Mg, Ca, Sr, Ba, Be and Ra, preferably Mg, Ca, Sr and Ba. The additional metal oxides may also include metals from Group 1A, i.e., Li, Na, K, Rb, Cs and Fr, preferably Li, Na and K. Metals from other Groups of the Periodic Table may also be suitable constituents of the metal oxide phases. For example, refractory metals such as Ti, V, Cr, Mn, Zr, Nb, Mo, Hf, Ta and W may be used. Furthermore, metals such as Al, Si, Sn, Pb and Bi may be used. In addition, the metal oxide phases may comprise rare earth metals such as Sc, Y, La, Ce, Pr, Nd and the like.

The additional metal oxides may include, for example, zirconnates, silicates, titanates, aluminates, stannates, niobates, tantalates and rare earth oxides.

Preferred additional metal oxides include Mg.sub.2SiO.sub.4, MgO, CaTiO.sub.3, MgZrSrTiO.sub.6, MgTiO.sub.3, MgAl.sub.2O.sub.4, WO.sub.3, SnTiO.sub.4, ZrTiO.sub.4, CaSiO.sub.3, CaSnO.sub.3, CaWO.sub.4, CaZrO.sub.3, MgTa.sub.2O.sub.6, MgZrO.sub.3, MnO.sub.2, PbO, Bi.sub.2O.sub.3 and La.sub.2O.sub.3. Particularly preferred additional metal oxides include Mg.sub.2SiO.sub.4, MgO, CaTiO.sub.3, MgZrSrTiO.sub.6, MgTiO.sub.3, MgAl.sub.2O.sub.4, MgTa.sub.2O.sub.6 and MgZrO.sub.3.

The additional metal oxide phases are typically present in total amounts of from about 1 to about 80 weight percent of the material, preferably from about 3 to about 65 weight percent, and more preferably from about 5 to about 60 weight percent. In one preferred embodiment, the additional metal oxides comprise from about 10 to about 50 total weight percent of the material. The individual amount of each additional metal oxide may be adjusted to provide the desired properties. Where two additional metal oxides are used, their weight ratios may vary, for example, from about 1:100 to about 100:1, typically from about 1:10 to about 10:1 or from about 1:5 to about 5:1. Although metal oxides in total amounts of from 1 to 80 weight percent are typically used, smaller additive amounts of from 0.01 to 1 weight percent may be used for some applications.

In one embodiment, the additional metal oxide phases may include at least two Mg-containing compounds. In addition to the multiple Mg-containing compounds, the material may optionally include Mg-free compounds, for example, oxides of metals selected from Si, Ca, Zr, Ti, Al and/or rare earths. In another embodiment, the additional metal oxide phases may include a single Mg-containing compound and at least one Mg-free compound, for example, oxides of metals selected from Si, Ca, Zr, Ti, Al and/or rare earths. The high Q tunable dielectric capacitor utilizes low loss tunable substrates or films.

To construct a tunable device, the tunable dielectric material can be deposited onto a low loss substrate. In some instances, such as where thin film devices are used, a buffer layer of tunable material, having the same composition as a main tunable layer, or having a different composition can be inserted between the substrate and the main tunable layer. The low loss dielectric substrate can include magnesium oxide (MgO), aluminum oxide (Al.sub.2O.sub.3), and lanthium oxide (LaAl.sub.2O.sub.3).

When the bias voltage or bias field is changed, the dielectric constant of the voltage tunable dielectric material (di-elect cons.sub.r) will change accordingly, which will result in a tunable varactor. Compared to semiconductor varactor based tunable filters, the tunable dielectric capacitor based tunable filters of this invention have the merits of lower loss, higher power-handling, and higher IP3, especially at higher frequencies (>10 GHz). It is observed that between 50 and 300 volts a nearly linear relation exists between Cp and applied Voltage.

In microwave applications the linear behavior of a dielectric varactor is very much appreciated, since it will assure very low Inter-Modulation Distortion and consequently a high IP3 (Third-order Intercept Point). Typical IP3 values for diode varactors are in the range 5 to 35 dBm, while that of a dielectric varactor is greater than 50 dBm. This will result in a much higher RF power handling capability for a dielectric varactor.

Another advantage of dielectric varactors compared to diode varactors is the power consumption. The dissipation factor for a typical diode varactor is in the order of several hundred milliwatts, while that of the dielectric varactor is about 0.1 mW.

Diode varactors show high Q only at low microwave frequencies so their application is limited to low frequencies, while dielectric varactors show good Q factors up to millimeter wave region and beyond (up to 60 GHz).

Tunable dielectric varactors can also achieve a wider range of capacitance (from 0.1 pF all the way to several .mu.F), than is possible with diode varactors. In addition, the cost of dielectric varactors is less than diode varactors, because they can be made more cheaply.

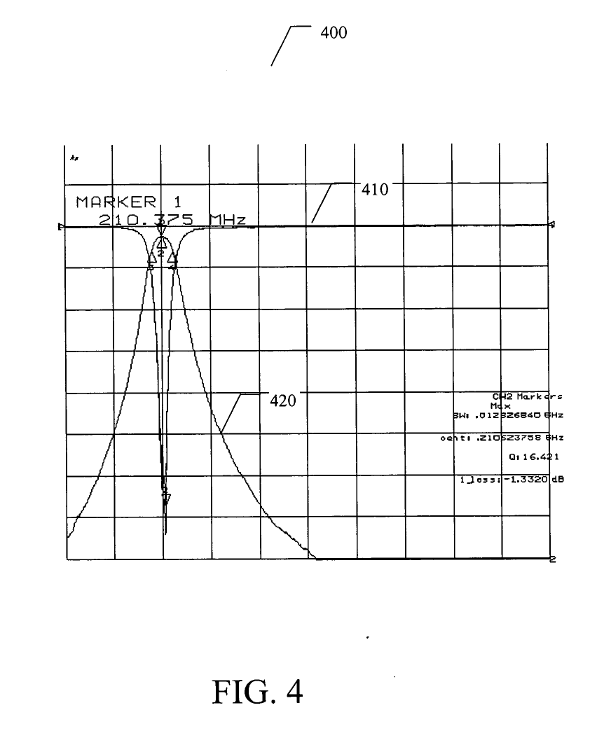

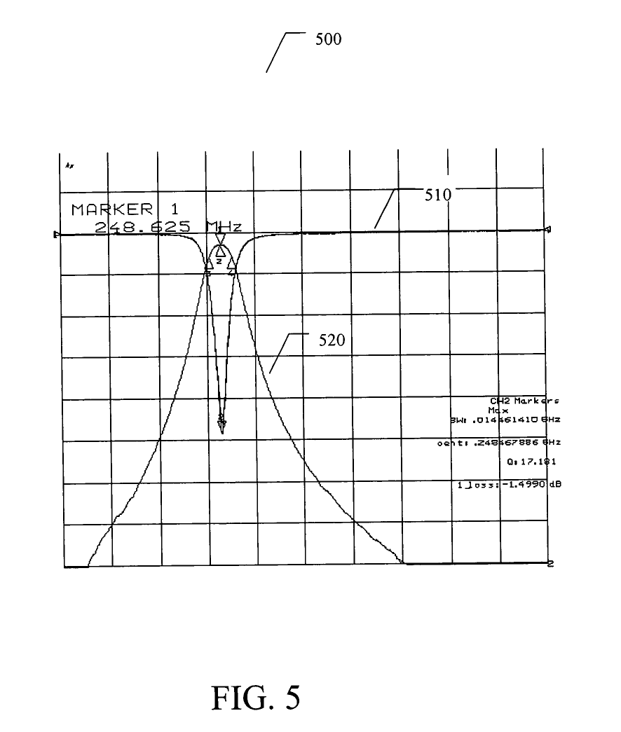

The response of a two-pole ridged waveguide cavity filter is presented in FIG. 4 at 400 with no bias and the same response under bias voltage is shown in FIG. 5 at 500.

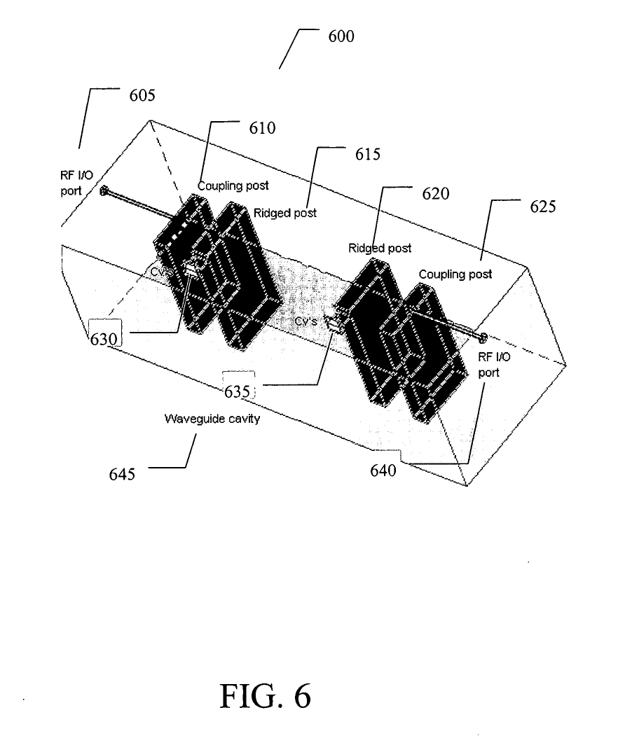

Turn now to FIG. 6 at 600 is as an alternative filter configuration with a two-pole tunable ridged waveguide cavity filter. In this filter configuration, tunable dielectric capacitors 630 and 635 may still be placed on the ridged posts 615 and 620, but filter input/output 605 and 640 coupling may be indirectly coupled from the ridged waveguide resonators via coupling posts 610 and 625. Meanwhile, inter-cavity coupling may be controlled by the distance and area of the ridged posts 615 and 620, instead of being controlled by a coupling iris.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

What is claimed is:

1. A voltage-controlled tunable filter, comprising:
a tunable ridged waveguide filter formed from a first ridged waveguide cavity coupled to a second ridged waveguide cavity thereby forming a resonator; and
one or more tunable capacitors in at least one of said first or second waveguide cavity.

2. The voltage-controlled tunable filter of claim 1, wherein said coupling between said first ridged waveguide and said second ridged waveguide is via a coupling iris or ridged post.

3. The voltage-controlled tunable filter of claim 1, wherein said one or more tunable capacitors comprises a low loss tunable dielectric material and metallic electrodes with predetermined shape, size, and distance.

4. The voltage-controlled tunable filter of claim 1, wherein said one or more tunable capacitors comprises are MEMS tunable capacitors.

5. The voltage-controlled tunable filter of claim 3, wherein said MEMS capacitor is a parallel plate or interdigital topology.

6. The voltage-controlled tunable filter of claim 1, wherein said tunable ridged waveguide filter is formed from two or more ridged-waveguide resonators.

7. The voltage-controlled tunable filter of claim 2, further comprising an RF Input and RF output connected to said resonator.

8. The voltage-controlled tunable filter of claim 7, wherein said RF input and RF output are direct coupling probes that are either electric or magnetic.

9. The voltage-controlled tunable filter of claim 7, wherein said RF input and RF output proximity coupling that are either electric or magnetic.

10. The voltage-controlled tunable filter of claim 9, wherein inter-cavity coupling is controlled by the distance and area of said ridged posts.

11. A method of manufacturing a voltage-controlled tunable filter, comprising:
forming a tunable ridged waveguide filter from a first ridged waveguide cavity coupled to a second ridged waveguide cavity thereby forming a resonator; and
placing one or more tunable capacitors in at least one of said first or second waveguide cavity.

12. The method of manufacturing a voltage-controlled tunable filter of claim 11, wherein said coupling between said first ridged waveguide and said second ridged waveguide is via a coupling iris or ridged post.

13. The method of manufacturing a voltage-controlled tunable filter of claim 11, further comprising forming said one or more tunable capacitors with a low loss tunable dielectric material and metallic electrodes with predetermined shape, size, and distance.

14. The method of manufacturing a voltage-controlled tunable filter of claim 11, wherein said one or more tunable capacitors comprises are MEMS tunable capacitors.

15. The method of manufacturing a voltage-controlled tunable filter of claim 11, wherein said MEMS capacitor is a parallel plate or interdigital topology.

16. The method of manufacturing a voltage-controlled tunable filter of claim 11, further comprising forming said tunable ridged waveguide filter from two or more ridged-waveguide resonators.

17. The method of manufacturing a voltage-controlled tunable filter of claim 11, further comprising integrating an RF Input and RF output with said resonator.

18. The method of manufacturing a voltage-controlled tunable filter of claim 17, wherein said RF input and RF output are direct coupling probes that are either electric or magnetic.

19. A voltage-controlled tunable filter, comprising:
a waveguide cavity;
at least one ridged post disposed therein; and
at least one tunable varactor within said waveguide cavity enabling tunability.

20. The voltage-controlled tunable filter of claim 19, further comprising at least one coupling post associated with said at least one ridged post, wherein inter-cavity coupling is controlled by the distance and area of said ridged posts.
